(19) United States
(12) Patent Application Publication
(10) Pub. No.: US 2019/0217450 A1
(43) Pub. Date: Jul. 18, 2019

(54) CHUCK WRENCH

(71) Applicant: Kennametal Inc., Latrobe, PA (US)

(72) Inventor: Robbie D. BLOOM, Hooversville, PA (US)

(21) Appl. No.: 15/869,753

(22) Filed: Jan. 12, 2018

(51) Int. Cl. B25B 13/44; B25B 13/48

(52) U.S. Cl. CPC B25B 13/44; B25B 13/481

(57) ABSTRACT

Chuck wrenches are disclosed that include a chuck engagement portion and a sleeve. The chuck engagement portion allows the chuck wrench and chuck to remain coaxial to provide stability to the chuck wrench and chuck assembly. The sleeve prevents a pinch point from being formed between the chuck wrench and the chuck. The chuck wrenches may be used in bolting operations such as mine roof support bolting.

### FIELD OF THE INVENTION

The present invention relates to chuck wrenches, and more particularly relates to chuck wrenches that may be used with mine roof support bolts.

### BACKGROUND

The expansion of underground mines such as coal mines involves digging or extending a tunnel or passage that initially has an unsupported roof. To stabilize and support the roof of the tunnel or passage, a roof bolt is normally inserted into the roof at a variety of locations. Similar procedures can also be undertaken for the roof of pre-existing tunnels or passages to provide additional roof support.

The roof bolts, are rotated in the drill holes by a mine bolting machine. A wrench which engages the head of a bolt is driven by the bolting machine. The typical wrench has an elongated shaft joined to a socket. In a conventional arrangement, the wrench is inserted into a chuck that is connected to or integral with the rotational drive. In order for the wrench and the chuck to remain coaxial, users are required to initially stabilize the connection with their hands. Furthermore, the insertion of the wrench into the chuck can create a pinch point between the bottom of the wrench and the top of the chuck.

### SUMMARY OF THE INVENTION

Chuck wrenches are provided that include a chuck engagement portion and a sleeve. The chuck wrenches may be used for roof bolting operations. In certain embodiments, the chuck engagement portion allows the chuck wrench and the chuck to remain coaxial to provide stability to the chuck wrench and chuck assembly. The sleeve prevents a pinch point from being formed between the chuck wrench and the chuck.

An aspect of the present invention is to provide a chuck wrench comprising a first wrench end having a chuck engagement portion comprising a chuck engagement core and a wrench alignment pin extending axially along a longitudinal axis of the chuck wrench structured and arranged to engage a central longitudinal bore of a chuck, a second wrench end, a wrench body extending from the second wrench end toward the first wrench end, and a sleeve surrounding the chuck engagement portion and extending beyond the chuck engagement core along the longitudinal axis.

Another aspect of the present invention is to provide a chuck and chuck wrench assembly comprising a chuck comprising an axial forward end having a generally cylindrical socket including a plurality of inwardly directed protrusions and a central longitudinal bore adjacent to the generally cylindrical socket, and a chuck wrench engageable with the chuck comprising a first wrench end having a chuck engagement portion comprising a chuck engagement core and a wrench alignment pin, a second wrench end, a wrench body extending from the second wrench end toward the first wrench end, and a sleeve surrounding the chuck engagement portion and extending beyond the chuck engagement core along the longitudinal axis.

These and other aspects of the present invention will be more apparent from the following description.

### BRIEF DESCRIPTION OF THE DRAWINGS

FIG. 1 is an isometric view of a chuck and chuck wrench assembly in accordance with an embodiment of the present invention.

FIG. 2 is an isometric view of a chuck wrench in accordance with an embodiment of the present invention.

FIG. 3 is an isometric view of a chuck in accordance with an embodiment of the present invention.

FIG. 4 is a left-end view of the chuck and chuck wrench assembly of FIG. 1.

FIG. 5 is a partially schematic cross-sectional view of the chuck and chuck wrench assembly taken through line 5-5 of FIG. 4.

FIG. 6 is a partially schematic cross-sectional view of the chuck and chuck wrench assembly taken through line 6-6 of FIG. 4.

FIG. 7 is a magnified cross-sectional view of the chuck and chuck wrench assembly taken through line 6-6 of FIG. 4.

FIG. 8 is a side view of the chuck wrench of FIG. 2.

FIG. 9 is a cross-sectional view of the chuck wrench taken through line 9-9 of FIG. 8.

FIG. 10 is a front view of the chuck wrench of FIG. 2.

FIG. 11 is a front view of the chuck of FIG. 3.

### DETAILED DESCRIPTION

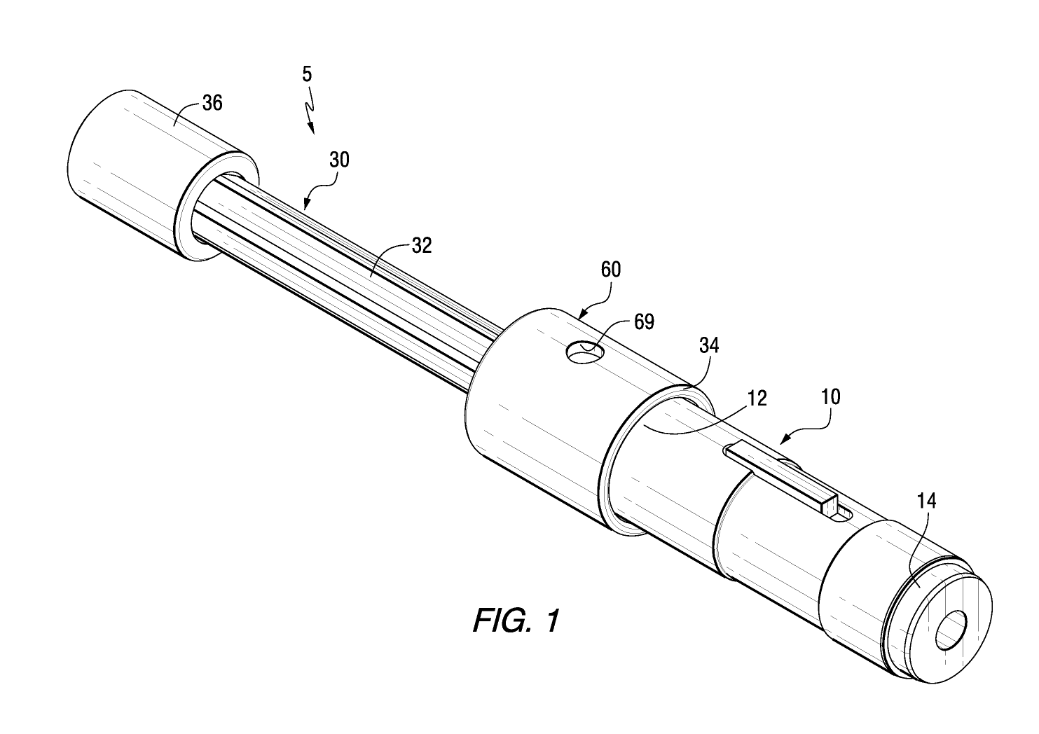

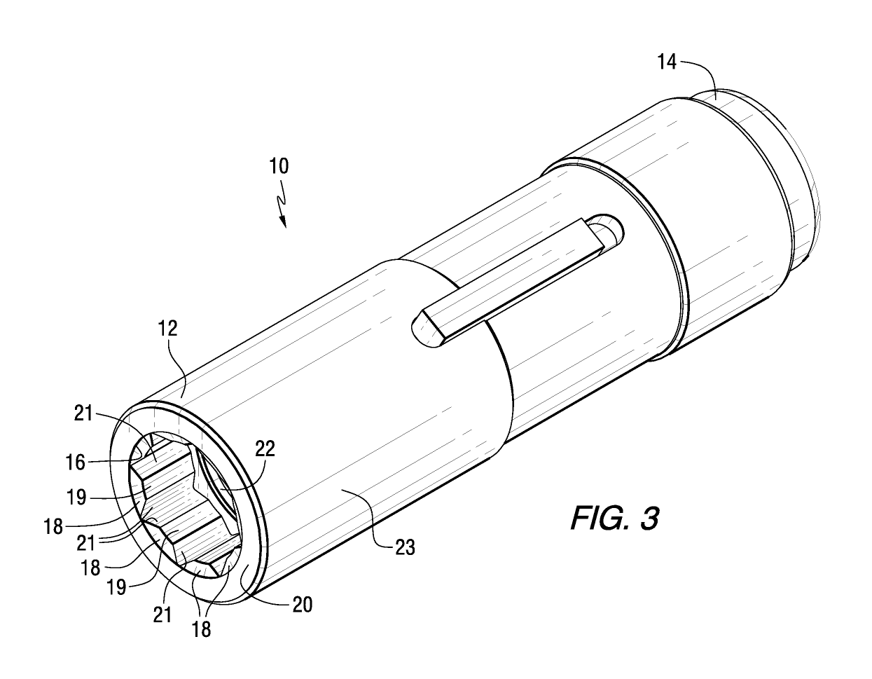

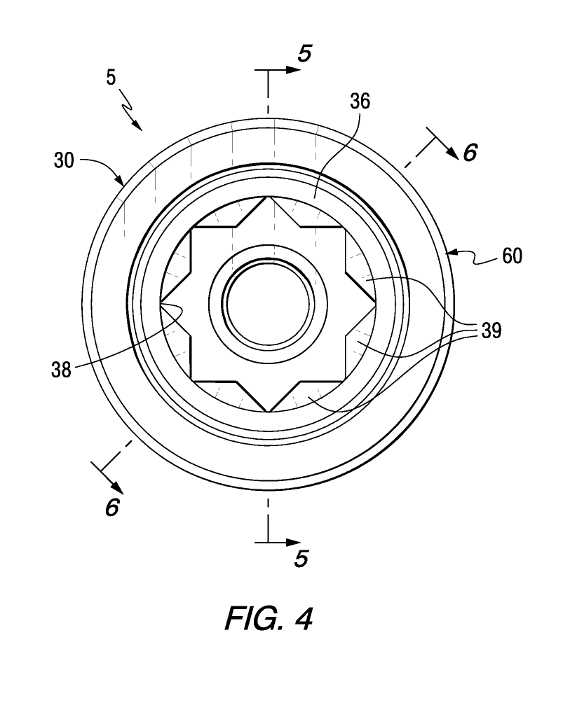

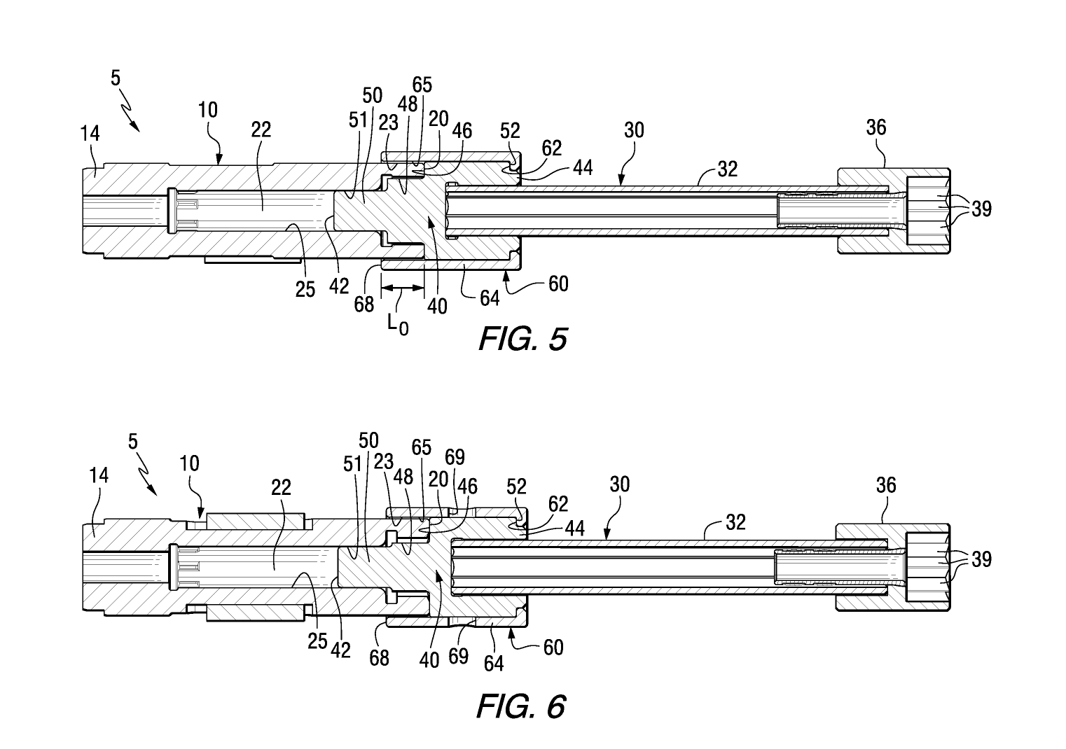

FIG. 1 illustrates a chuck and chuck wrench assembly 5 in accordance with an embodiment of the present invention. The chuck and chuck wrench assembly 5 includes a chuck 10 and a chuck wrench 30. As shown in FIG. 3, the chuck 10 has an axial forward, or top end 12 and an axial rearward, or bottom end 14. The forward end 12 comprises a front face 20, an outer chuck surface 23 and a generally cylindrical socket 16. In the embodiment shown, the generally cylindrical socket 16 includes a set of inwardly directed protrusions 18, disposed about an inner circumference of the socket 16, for engaging the chuck wrench 30, as more fully described below and as illustrated in FIGS. 5-7. In the embodiment shown, there are eight inwardly directed protrusions 18, but any other suitable number of protrusions may be used. For example, there may be two, three, four, five, six, seven, nine, ten or more protrusions. In the embodiment shown, the inwardly directed protrusions 18 are defined by an innermost arcuate surface 19 and a pair of sloped side surfaces 21 extending radially outwardly, circumferentially between adjacent innermost arcuate surfaces 19. However, any other suitable shape and arrangement of protrusion may be used, e.g., parabolic, rectangular or the like. As shown in FIGS. 3 and 5-7, the chuck 10 comprises a central longitudinal bore 22 having an interior surface 25 adjacent to the generally cylindrical socket 16. In accordance with an embodiment of the present invention, the center of the central longitudinal bore 22 corresponds to a longitudinal axis of the chuck 10. In accordance with an embodiment of the present invention, the rearward end 14 of the chuck 10 is structured and arranged to be inserted into a rotational drive (not shown). In certain embodiments, the chuck and chuck wrench assembly 5 may be used for the installation of mine roof support bolts or mine support bolts.

As shown in FIG. 11, the outer surface 23 of the chuck 10 forms an outer chuck diameter D_{O} that may be varied depending on the rotational drive. For example, the outer chuck diameter D_{O} of the chuck 10 may typically range from 0.5 to 5 inches, or from 1 to 4 inches, or from 1.5 to 3 inches.

In accordance with an embodiment of the present invention, the central longitudinal bore 22 of the chuck 10 can be similar to the central bore disclosed in U.S. patent application Ser. No. 15/686,868, entitled “Spline Drive Drill Steel Couplers” filed on Aug. 25, 2017, which is incorporated herein by reference. In the embodiment shown, the central longitudinal bore 22 is cylindrical in shape, so as to better accommodate a drill steel (not shown) with a cylindrical outer surface. As shown in FIG. 11, the interior surface 25 of the central longitudinal bore 22 forms an inner diameter D_{B} selected to accommodate drill steels. For example, the inner diameter D_{B} of the central longitudinal bore 22 may typically range from 0.2 to 3 inches, or from 0.5 to 2 inches, or from 0.75 to 1.5 inches. In the embodiment shown, the central longitudinal bore 22 is substantially cylindrical, however, any other suitable shape of bore may be used, e.g., rectangular, square, triangular, ovular, hexagonal, D-shaped or the like.

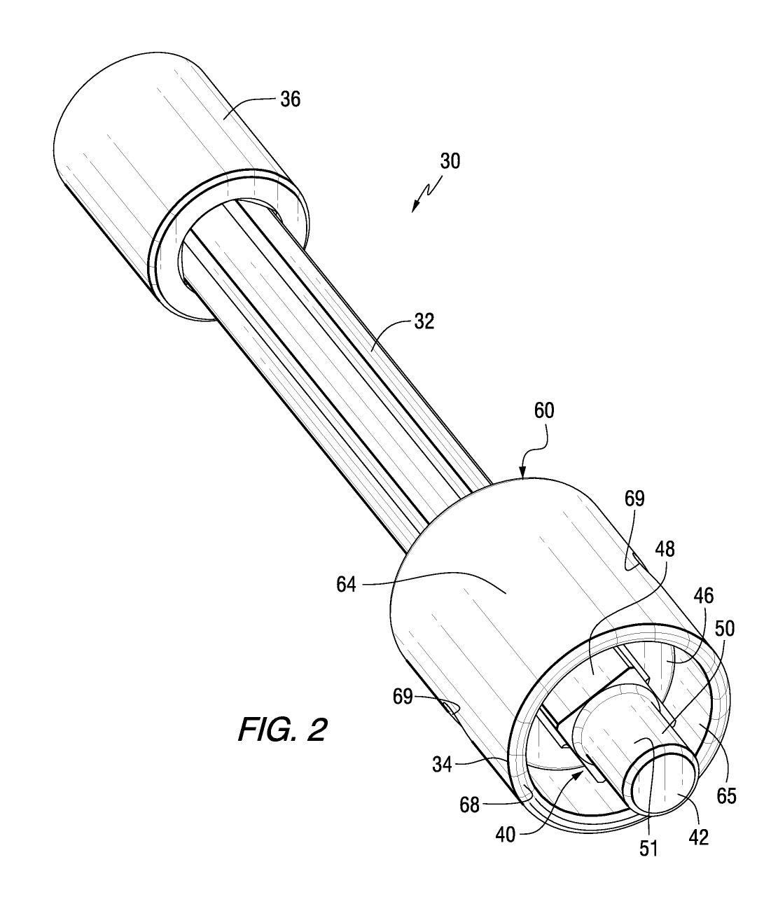

As shown in FIGS. 1 and 2, the chuck wrench 30 has a wrench body 32, a first wrench end 34 and a second wrench end 36. In the embodiment shown, the wrench body 32 is substantially hexagonal, however any other suitable shape of wrench body may be used, e.g., cylindrical, ovular, rectangular, triangular or the like. The first wrench end 34 is typically adjacent to the chuck 10, as shown in FIG. 1, and the second wrench end 36 is typically adjacent to a mine roof support bolt (not shown). As shown in FIG. 3, the second wrench end 36 of the chuck wrench 30 comprises a generally cylindrical bolt socket 38 having a set of inwardly directed protrusions 39 structured and arranged to engage a mine roof support bolt (not shown) that is to be installed in a drilled hole. In accordance with an embodiment of the present invention, any other suitable shape and/or arrangement of bolt socket may be used to engage any shape or size of mine roof support bolt.

As shown in FIG. 2, the first wrench end 30 comprises a chuck engagement portion 40 having a first end 42 at the first wrench end 34 and a second end 44 adjacent to the wrench body 32. In accordance with an embodiment of the present invention, the chuck engagement portion 40 comprises a face 46, a chuck engagement core 48, a wrench alignment pin 50 and a sleeve receiving shoulder 52. The chuck engagement core 48 extends from the face 46 in a direction parallel with a longitudinal axis of the chuck wrench 30. In the embodiment shown, the chuck engagement core 48 is substantially square, however, any other suitable shape of engagement core may be used, e.g., rectangular, triangular, hexagonal, ovular, or the like. The wrench alignment pin 50 extends from the chuck engagement core 48 in a direction parallel with the longitudinal axis of the chuck wrench 30. In accordance with an embodiment of the present invention, the wrench alignment pin 50 is substantially cylindrical as more fully described below and illustrated in FIGS. 2 and 5-7. In the embodiment shown, the wrench alignment pin 50 is substantially cylindrical, however, any other suitable shape of alignment pin may be used, e.g., rectangular, square, triangular, ovular, hexagonal, D-shaped or the like.

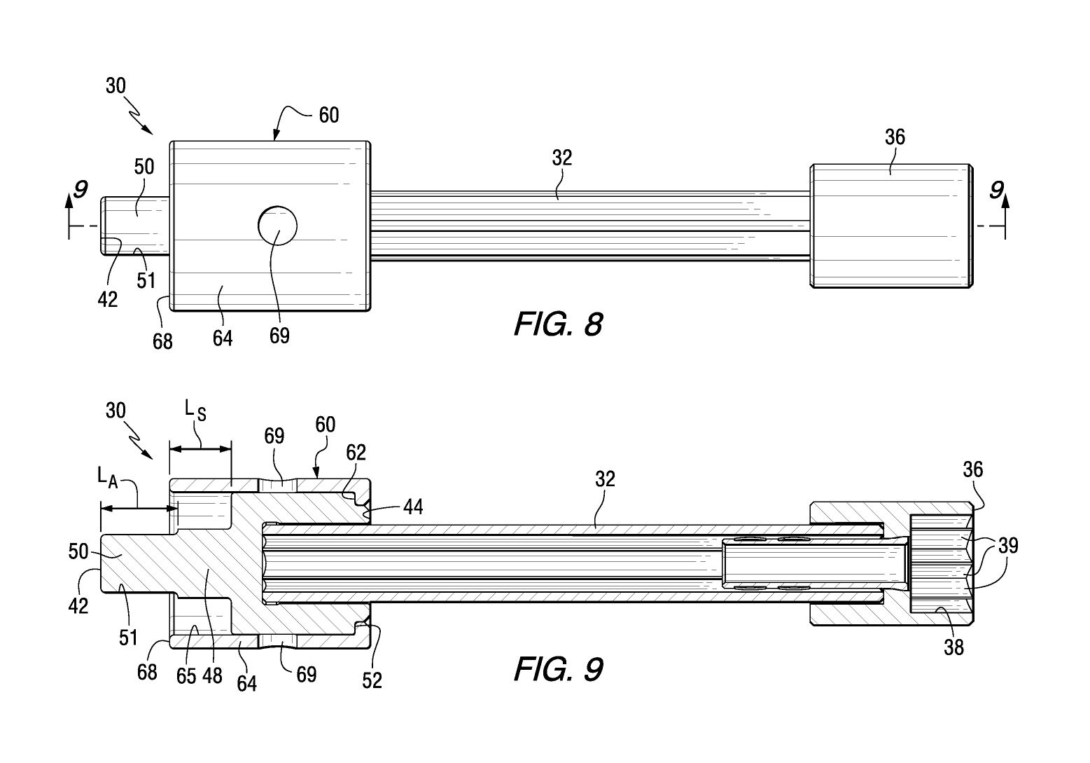

As shown in FIGS. 2 and 5-7, a sleeve 60 is provided surrounding the chuck engagement portion 40. The sleeve 60 comprises a wrench engagement portion 62, a substantially cylindrical body 64, an inner surface 65, and an outer rim 68. In accordance with an embodiment of the present invention, the substantially cylindrical body 64 and the outer rim 68 define a chuck receiving opening having an inner diameter selected based upon the outer diameter of the chuck it receives. In the embodiment shown, the sleeve 60 is weldably attached onto the chuck engagement portion 40. However, any other suitable arrangement may be used, e.g., mechanical fasteners, magnets, or the like. Alternatively, the sleeve 60 may be threadingly engaged with the chuck engagement portion 40 or integrally formed with the chuck wrench 30. In accordance with an embodiment of the present invention, the wrench engagement portion 62 engages the sleeve receiving shoulder 52 of the chuck engagement portion 40. As shown in FIGS. 1 and 6-9, the substantially cylindrical body 64 includes sleeve securing holes 69 that allow the sleeve 60 to be weldably attached to chuck engagement portion 40.

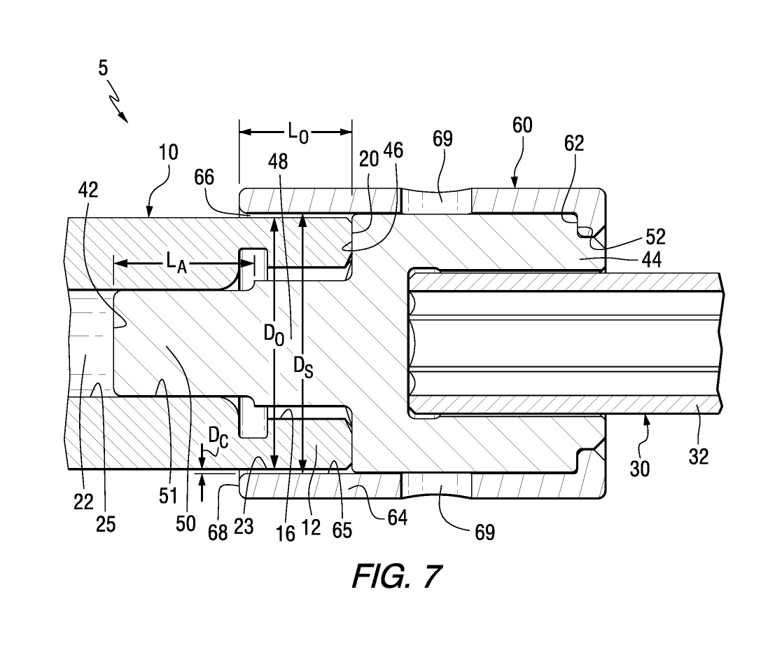

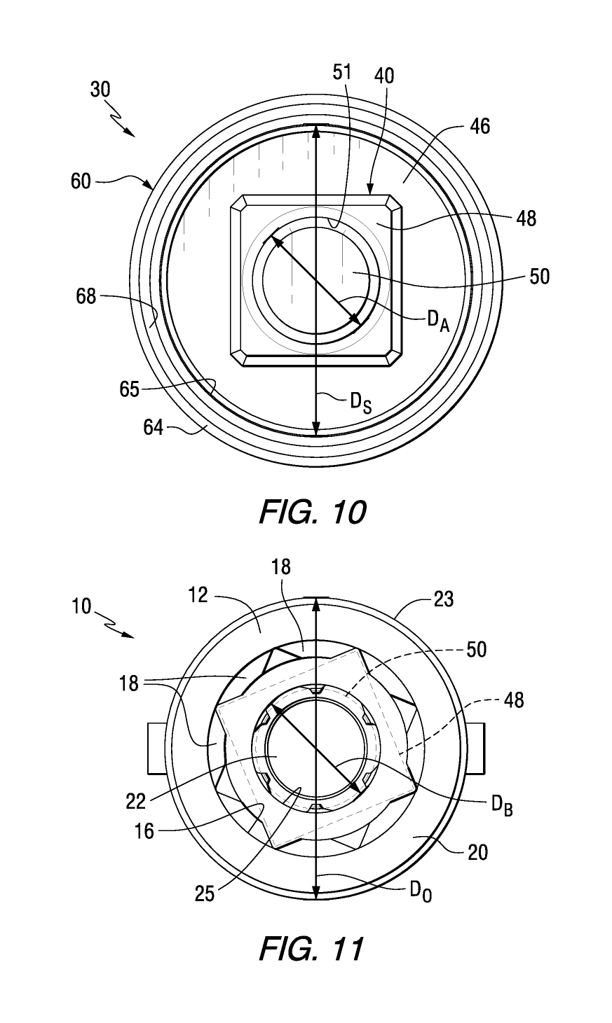

In accordance with an embodiment of the present invention, the substantially cylindrical body 64 of the sleeve 60 forms a socket to receive the axial forward end 12 of the chuck 10. As shown in FIGS. 7 and 10, the inner surface 65 of the substantially cylindrical body 64 of the sleeve 60 has an internal sleeve diameter D_{S} that may be varied depending on the outer chuck diameter D_{O} of the chuck 10. For example, the internal sleeve diameter D_{S} of the sleeve 60 may typically range from 0.5 to 5 inches, or from 1 to 4 inches, or from 1.5 to 3 inches. The internal sleeve diameter D_{S} may be selected to reduce or prevent a pinch point, e.g., for fingers, between the sleeve 60 and the axial forward end 12 of the chuck 10. For example, the internal sleeve diameter D_{S} of the sleeve 60 may be from zero to 0.5 inch greater than the outer chuck diameter D_{O}, e.g., from 0.001 to 0.25 inches greater, or from 0.01 to 0.15 inches greater. Thus, as shown in FIG. 7, a radial gap 66 defines a clearance distance D_{C} between the outer surface 23 of the chuck 10 and the inner surface 65 of the sleeve 60. For example, the clearance distance D_{C} between the outer surface 23 of the chuck 10 and the inner surface 65 of the sleeve 60 may be from zero to 0.25 inch, or from 0.0005 to 0.125 inch, or from 0.005 to 0.075 inch. The clearance distance D_{C} allows for the sleeve 60 to easily engage the axial forward end 12 of the chuck 10 while preventing fingers or clothing from being caught between the chuck wrench 30 and the chuck 10. In certain embodiments, there could zero tolerance or clearance distance D_{C} between the inner surface 65 of the sleeve 60 and the outer surface 23 of the chuck 10 to provide additional stability to the chuck and chuck wrench assembly 5. In the embodiment shown, the sleeve 60 is cylindrical to engage the forward end 12 of the chuck 10, however, any other suitable shape of sleeve to engage the any suitable shape of chuck may be used, e.g., rectangular, triangular, hexagonal, ovular, or the like.

In accordance with an embodiment of the present invention, the chuck engagement core 48 is structured and arranged for engaging with the generally cylindrical socket 16 and inwardly directed protrusions 18 of the chuck 10, to facilitate transmission of torque from the chuck 10 to the wrench 30. As shown in FIGS. 5-7, the chuck engagement core 48 of the chuck wrench 30 may be sized to be brought into a torque-transmitting relationship with the inwardly directed protrusions 18 of the generally cylindrical socket 16 when the wrench is engaged with the chuck 10, e.g., when the chuck engagement portion 40 is inserted axially into the axial forward end 12 of the chuck 10. In FIG. 10, the chuck engagement core 48 is shown as having a beveled peripheral edge. The peripheral edge may be provided on the chuck engagement core 48 in order to facilitate the insertion of the chuck engagement core 48 into the socket 16.

FIGS. 5 and 6 are cross-sectional views illustrating how the chuck engagement portion 40 is received in the generally cylindrical socket 16 and central longitudinal bore 22 of the chuck 10. As shown in FIG. 5, corner portions of the chuck engagement core 48 are in contact with the sloped side surfaces 21 of the inwardly directed protrusions 18 of the generally cylindrical socket 16. Such a relationship allows for a torque-transmitting relationship between the chuck 10 and the chuck wrench 30. As shown in FIG. 6, the flat portions of the chuck engagement core 48 are not in contact with the inwardly directed protrusions 18 of the generally cylindrical socket 16.

As shown in FIGS. 5-7, when the chuck wrench 30 is engaged with the chuck 10, the front face 20 of the axial forward end 12 of the chuck 10 may be in contact with the face 46 of the of the chuck engagement portion 40 of the chuck wrench 30. The contact between the chuck 10 and chuck wrench 30 may provide an axial force against the mine support bolt during installation.

As shown in FIGS. 5-10, the wrench alignment pin 50 of the engagement portion 40 extends axially from the chuck engagement core 48. As shown in FIG. 9, the wrench alignment pin 50 has an axial length L_{A} that allows the wrench alignment pin 50 to extend into the central longitudinal bore 22 of the chuck 10. For example, the axial length L_{A} of the wrench alignment pin 50 may be at least 0.2 inch, for example, from 0.25 to 3 inches, or from 0.5 to 2 inches, or from 0.75 to 1.5 inches. The axial length L_{A} is selected to allow the wrench alignment pin 50 to extend into the central longitudinal bore 22 of the chuck 10 to provide the chuck and chuck wrench assembly 5 with stability and protects against lateral forces which may result in the chuck 10 and the chuck wrench 30 becoming misaligned. The chuck 10 and chuck wrench 30 remaining coaxial allows a longitudinal force to be applied to a mine roof support bolt during installation. The wrench alignment pin 50 reduces or eliminates unwanted lateral movement of the wrench 30 in the chuck 10 without the user being required to use their hands.

As shown in FIG. 10, the wrench alignment pin 50 has an outer surface 51 that forms an outer diameter D_{A} that is selected to allow the wrench alignment pin 50 be inserted in the central longitudinal bore 22 of the chuck 10. For example, the outer diameter D_{A} of the alignment pin 50 may typically range from at least 0.2 to 3 inches, or from 0.5 to 2 inches, or from 0.75 to 1.5 inches. In accordance with an embodiment of the present invention, the wrench alignment pin 50 may be configured to form a slip fit with the central longitudinal bore 22 of the chuck 10 to allow for coaxial alignment. In accordance with an embodiment of the present invention, the outer surface 51 of the wrench alignment pin 50 engages or fits within the interior surface 25 of the central longitudinal bore 22 to center the chuck wrench 30 in the chuck 10. For example, the outer diameter D_{A} of the wrench alignment pin 50 may be from zero to 0.2 inch less than the inner diameter D_{B} of the central longitudinal bore 22, e.g., from 0.002 to 0.1 inches, or from 0.005 to 0.02 inches. However, any other suitable type of fit between the wrench alignment pin 50 and the central longitudinal bore 22 may be used, such as, a slide fit, a press fit, or the like. In accordance with an embodiment of the present invention, the shape of the wrench alignment pin 50 is selected to correspond to the shape of the central longitudinal bore 22 of the chuck 10. The corresponding shapes allows the outer surface 51 of the wrench alignment pin 50 to form a relationship with the inner surface 25 of the central longitudinal bore 22.

The end view of FIG. 11 illustrates the sloped side surface 21 of the inwardly directed protrusions 18 of the generally cylindrical socket 16 of the chuck 10, and the chuck engagement core 48 of the chuck wrench 30, as shown in phantom, in engagement with the sloped slide surfaces 21. FIG. 11 also shows the inner surface 25 of the central longitudinal bore 22 of the chuck 10 with the wrench alignment pin 50 of the chuck wrench 30 shown in phantom inserted within the central longitudinal bore 22. In accordance with an embodiment of the present invention, the radial distance between the wrench alignment pin 50 and the inner surface 25 of the central longitudinal bore 22 defines a clearance distance therebetween that is determined by the selection of the outer diameter D_{A} of the wrench alignment pin 50 and the inner diameter D_{B} of the central longitudinal bore 22, as discussed above. Thus, the clearance distance between the outer surface 51 of the wrench alignment pin 50 and the inner surface 25 of the central longitudinal bore 22 may be from zero to 0.1 inch, or from 0.001 to 0.05 inch, or from 0.0025 to 0.01 inch. The chuck engagement core 48 and the wrench alignment pin 50 of the chuck wrench 30 are configured to be in a relationship with the generally cylindrical socket 16 and central longitudinal bore 22 of the chuck 10 such that the longitudinal axis of the chuck 10 and the longitudinal axis of the chuck wrench 30 are coaxial.

As shown in FIG. 5, when the chuck wrench 30 is engaged with the chuck 10, the sleeve 60 has an overlap length L_{O} over the axial forward end of the chuck. For example, the overlap length L_{O} may be at least 0.2 inch, for example from 0.25 to 3 inches, or from 0.5 to 2 inches, or from 0.75 to 1.5 inches. The overlap length L_{O} is desirable to eliminate a pinch point from being formed and to provide additional stability to the chuck wrench 30 and chuck 10 engagement. Additional stability allows the chuck wrench 30 to remain coaxial with the chuck 10 during installation of a mine roof support bolt. As shown in FIG. 9, the overlap length L_{O} is formed by the outer rim 68 of sleeve 60 extending axially past the face 46 of the chuck engagement portion 40 to create an axial socket length L_{S}. The axial socket length L_{S} allows the sleeve 60 to extend axially beyond the chuck engagement core 48 and for a portion of the chuck 30 to be received within the sleeve 60. For example, the axial socket length L_{S} may be at least 0.2 inch, for example from 0.25 to 3 inches, or from 0.5 to 2 inches, or from 0.75 to 1.5 inches.

The chuck 10 and chuck wrench 30 may be made of any suitable material, such as steel, aluminum, titanium or any other material having sufficient strength. The chuck wrench of the present invention may be fabricated by any suitable technique, such as machining to provide the chuck engagement portion and inwardly directed protrusions.

For purposes of the description above, it is to be understood that the invention may assume various alternative variations and step sequences except where expressly specified to the contrary. Moreover, all numbers expressing, for example, quantities of ingredients used in the specification and claims, are to be understood as being modified in all instances by the term “about”. Accordingly, unless indicated to the contrary, the numerical parameters set forth are approximations that may vary depending upon the desired properties to be obtained by the present invention. At the very least, and not as an attempt to limit the application of the doctrine of equivalents, each numerical parameter should at least be construed in light of the number of reported significant digits and by applying ordinary rounding techniques.

It should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

In this application, the use of the singular includes the plural and plural encompasses singular, unless specifically stated otherwise. In addition, in this application, the use of “or” means “and/or” unless specifically stated otherwise, even though “and/or” may be explicitly used in certain instances. In this application, the articles “a,” “an,” and “the” include plural referents unless expressly and unequivocally limited to one referent.

Whereas particular embodiments of this invention have been described above for purposes of illustration, it will be evident to those skilled in the art that numerous variations of the details of the present invention may be made without departing from the invention as defined in the appended claims.

What is claimed is:

1. A chuck wrench comprising:
a first wrench end having a chuck engagement portion comprising a chuck engagement core and a wrench alignment pin extending axially along a longitudinal axis of the chuck wrench structured and arranged to engage a central longitudinal bore of a chuck;
a second wrench end;
a wrench body extending from the second wrench end toward the first wrench end; and
a sleeve surrounding the chuck engagement portion and extending beyond the chuck engagement core along the longitudinal axis.

2. The chuck wrench of claim 1, wherein the wrench alignment pin is substantially cylindrical.

3. The chuck wrench of claim 1, wherein the wrench alignment pin has an axial length of from 0.2 to 2 inches.

4. The chuck wrench of claim 1, wherein the sleeve has an axial socket length of 0.2 to 3 inches.

5. The chuck wrench of claim 1, wherein the sleeve has an internal diameter structured and arranged to provide a clearance distance of from zero to 0.25 inch with an outer chuck diameter of a chuck.

6. The chuck wrench of claim 1, wherein the chuck engagement core is substantially square.

7. The chuck wrench of claim 1, wherein the sleeve is weldably attached to the chuck engagement portion.

8. The chuck wrench of claim 1, wherein the sleeve is integrally formed with the chuck engagement portion.

9. The chuck wrench of claim 1, wherein the second wrench end is structured and arranged to engage a mine roof support bolt.

10. The chuck wrench of claim 1, wherein the sleeve comprises a substantially cylindrical body having an inner surface, and the sleeve has an internal sleeve diameter of from 1 to 4 inches.

11. A chuck and chuck wrench assembly comprising:
a chuck comprising an axial forward end having a generally cylindrical socket including a plurality of inwardly directed protrusions and a central longitudinal bore adjacent to the generally cylindrical socket; and
a chuck wrench engageable with the chuck comprising:
a first wrench end having a chuck engagement portion comprising a chuck engagement core and a wrench alignment pin;
a second wrench end;
a wrench body extending from the second wrench end toward the first wrench end; and
a sleeve surrounding the chuck engagement portion and extending beyond the chuck engagement core along the longitudinal axis.

12. The chuck and chuck wrench assembly of claim 11, wherein the central longitudinal bore is substantially cylindrical and comprises an inner surface, and the central longitudinal bore has an inner diameter of from 0.25 to 3 inches.

13. The chuck and chuck wrench assembly of claim 11, wherein the wrench alignment pin is substantially cylindrical and comprises an outer surface, and the wrench alignment pin has an outer diameter of from 0.25 to 3 inches.

14. The chuck and chuck wrench assembly of claim 11, wherein an outer diameter of the wrench alignment pin is from 0 to 0.2 inches less than an inner diameter of the central longitudinal bore.

15. The chuck and chuck wrench assembly of claim 14, wherein the wrench alignment pin forms a slip fit with the inner diameter of the central longitudinal bore.

16. The chuck and chuck wrench assembly of claim 11, wherein the sleeve is substantially cylindrical and comprises an inner surface, and the sleeve has an internal sleeve diameter of from 1 to 4 inches.

17. The chuck and chuck wrench assembly of claim 11, wherein the axial forward end of the chuck is substantially cylindrical and comprises an outer surface, and the chuck has an outer chuck diameter of from 1 to 4 inches.

18. The chuck and chuck wrench assembly of claim 11, further comprising a radial gap defining a clearance distance between an inner surface of the sleeve and an outer surface of the axial forward end of the chuck of from zero to 0.25 inch.

19. The chuck and chuck wrench assembly of claim 11, wherein the sleeve has an overlap length of at least 0.2 inch over the axial forward end of the chuck.

20. The chuck and chuck wrench assembly of claim 18, wherein the overlap length is from 0.5 to 2 inches.

21. The chuck and chuck wrench assembly of claim 11, wherein the longitudinal axis of the chuck is coaxial with the longitudinal axis of the chuck wrench.

22. The chuck and chuck wrench assembly of claim 11, wherein the chuck engagement core is torquably associated with the plurality of inwardly directed protrusions of chuck.

23. The chuck and chuck wrench assembly of claim 11, wherein the second wrench end is structured and arranged to engage a mine roof support bolt.
